(19) United States
(12) Patent Application Publication
(10) Pub. No.: US 2025/0291214 A1
(43) Pub. Date: Sep. 18, 2025

(54) DISPLAY DEVICE

(71) Applicant: Japan Display Inc., Tokyo (JP)

(72) Inventor: Hirotaka HAYASHI, Tokyo (JP)

(21) Appl. No.: 19/058,368

(22) Filed: Feb. 20, 2025

(30) Foreign Application Priority Data
Mar. 13, 2024 (JP) 2024-039041

(51) Int. Cl. G02F 1/1334; G02F 1/1333; G02F 1/1343

(52) U.S. Cl. CPC G02F 1/1334; G02F 1/133368; G02F 1/13439

(57) ABSTRACT

According to one embodiment, a display device includes an array substrate including a plurality of pixel electrodes provided in a display area, a counter-substrate overlapping the array substrate, and a liquid crystal layer containing polymer dispersed liquid crystals and provided between the array substrate and the counter-substrate. The counter-substrate includes a transparent electrode facing the plurality of pixel electrodes and capable of heating the liquid crystal layer.

### CROSS-REFERENCE TO RELATED APPLICATIONS

This application is based upon and claims the benefit of priority from Japanese Patent Application No. 2024-039041, filed Mar. 13, 2024, the entire contents of which are incorporated herein by reference.

### FIELD

Embodiments described herein relate generally to a display device.

### BACKGROUND

In recent years, display devices comprising a display panel including a polymer dispersed liquid crystal layer (PDLC), a light source, and the like have been proposed. Polymer dispersed liquid crystal layers can switch a scattering state for scattering light beams and a transparent state for transmitting light beams.

The display device can display images in the scattering state. Switching the scattering state of the display panel to the transparent state allows a user to visually recognize a background through the display panel.

### BRIEF DESCRIPTION OF THE DRAWINGS

FIG. 1 is a view showing a configuration example of a display device of an embodiment.

FIG. 2 is a schematic cross-sectional view of the display device of an embodiment.

FIG. 3 is a schematic plan view of a display device of an embodiment.

FIG. 4 is a schematic perspective view of a display device of an embodiment.

FIG. 5 is a schematic cross-sectional view of the display device along V-V line of FIG. 4.

FIG. 6 is a block view containing a control circuit of an embodiment.

FIG. 7 is a circuit diagram of a display device of an embodiment.

FIG. 8 is a flowchart showing an example of heat control in a control circuit.

FIG. 9 is a flowchart showing an example of an image display control in a control circuit.

FIG. 10 is a diagram for explanations on a first mode in image display control.

FIG. 11 is a diagram for explanations on the first mode in the image display control.

### DETAILED DESCRIPTION

In general, according to one embodiment, a display device includes an array substrate including a plurality of pixel electrodes provided in a display area, a counter-substrate overlapping the array substrate, and a liquid crystal layer containing polymer dispersed liquid crystals and provided between the array substrate and the counter-substrate. The counter-substrate includes a transparent electrode facing the plurality of pixel electrodes and capable of heating the liquid crystal layer.

This configuration enables a display device capable of improving display qualities.

Embodiments will be described hereinafter with reference to the accompanying drawings. Note that the disclosure is presented for the sake of exemplification, and any modification and variation conceived within the scope and spirit of the invention by a person having ordinary skill in the art are naturally encompassed in the scope of invention of the present application.

In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements which function in the same or a similar manner to those described in connection with preceding drawings are denoted by like reference numbers, detailed description thereof being omitted unless necessary.

In the figures, an X axis, a Y axis, and a Z axis orthogonal to each other are described to facilitate understanding as needed. A direction along the X axis is referred to as a first direction X, a direction along the Y axis is referred to as a second direction Y, and a direction along the Z axis is referred to as a third direction Z. A plan view is defined as appearance when various types of elements are viewed parallel to the third direction Z.

As an example of display devices, embodiments disclose a liquid crystal display device (a transparent display device) that adopts polymer dispersed liquid crystals and has a high light translucency. However, the configurations disclosed in the present embodiment can be applied to other types of display devices.

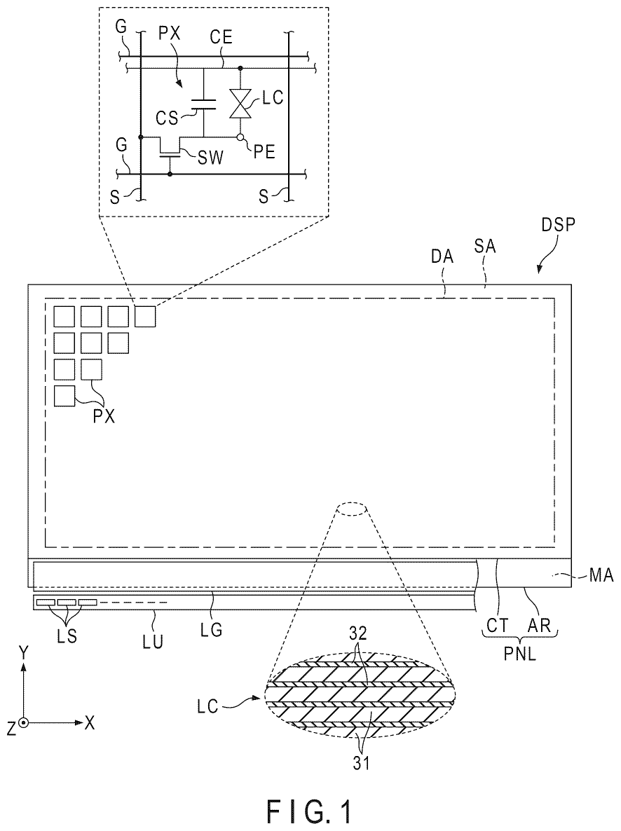

FIG. 1 is a diagram showing a configuration example of a display device DSP of the present embodiment. FIG. 1 shows the display device DSP in the opposite direction to the third direction Z.

The display device DSP comprises a display panel PNL, a light source unit LU, and a light guide LG. FIG. 1 highlights the light source unit LU and the light guide LG with break lines and partially omits illustration of these portions.

The display panel PNL comprises an array substrate AR and a counter-substrate CT stacked in the third direction Z. The counter-substrate CT faces the array substrate AR. Each of the array substrate AR and the counter-substrate CT in FIG. 1 has a rectangular shape elongating in the first direction X. The array substrate AR and the counter-substrate CT may have a shape different from this example.

The width of the array substrate AR in the second direction Y is greater than the width of the counter-substrate CT in the second direction Y. This configuration allows the array substrate AR to include a mounting area MA provided at a position not overlapping the counter-substrate CT. The mounting area MA has a printed circuit board to be described later and the like.

The display panel PNL includes a display area DA which displays images and a surrounding area SA having a frame shape and surrounding the display area DA. Both the display area DA and the surrounding area SA are formed on portions on which the array substrate AR overlaps the counter-substrate CT. The display area DA comprises a plurality of pixels PX arranged in a matrix in the first direction X and the second direction Y.

The display panel PNL further includes a liquid crystal layer LC enclosed between the array substrate AR and the counter-substrate CT. As shown in a lower side of FIG. 1 in the enlarged and schematic manner, the liquid crystal layer LC is composed of a polymer dispersed liquid crystals containing polymers 31 and liquid crystal molecules 32.

For example, the polymers 31 are liquid crystal polymers. The polymers 31 are formed in stripe shapes extending along the first direction X and are arranged in the second direction Y. The liquid crystal molecules 32 are dispersed in gaps between the polymers 31 and are arranged such that the longer axes of the liquid crystal molecules 32 are along the first direction X.

Each of the polymers 31 and the liquid crystal molecules 32 has optical anisotropy or refractive anisotropy. A response performance of the polymer 31 to the electric field is lower than a response performance of the liquid crystal molecules 32 to the electric field. For example, the alignment direction of the polymers 31 hardly varies irrespective of the presence or absence of the electric field. In contrast, the alignment direction of the liquid crystal molecules 32 varies in response to a voltage applied to the liquid crystal layer LC.

When no voltage is applied to the liquid crystal layer LC, the optical axes of the polymers 31 are parallel to those of the liquid crystal molecules 32, and light beams made incident on the liquid crystal layer LC are not substantially scattered by the liquid crystal layer LC and these light beams pass through the liquid crystal layer LC (the transparent state).

When a voltage is applied to the liquid crystal layer LC, the optical axes of the polymers 31 intersect those of the liquid crystal molecules 32, and the light beams made incident on the liquid crystal layer LC are scattered by the liquid crystal layer LC (the scattering state).

As shown in the upper side of FIG. 1 in the enlarged manner, a plurality of scanning lines G and a plurality of signal lines S are provided in the display area DA. The plurality of scanning lines G extend in the first direction X and are arranged in the second direction Y. The plurality of signal lines S extend in the second direction Y and are arranged in the first direction X.

Each pixel PX comprises a switching element SW, a pixel electrode PE, a common electrode CE, and a capacity CS. The switching element SW is constituted by, for example, a thin-film transistor (TFT) and is electrically connected to the scanning line G and the signal line S. The pixel electrode PE is electrically connected to the switching element SW.

The liquid crystal layer LC (particularly, the liquid crystal molecules 32) is driven by an electric field produced between the pixel electrode PE and the common electrode CE. The common electrode CE is shared by a plurality of pixel electrodes PE. A capacitor CS is formed, for example, between the common electrode CE and an electrode having the same electric potential as the common electrode CE and between the pixel electrode PE and an electrode having the same electric potential as the pixel electrode PE.

The light source unit LU and the light guide LG are provided along the mounting area MA. The light source unit LU comprises a plurality of light sources LS arranged in the first direction X. Each of the plurality of light sources LS emits light beams to the display panel PNL along the second direction Y via the light guide LG. Examples of the light guide LG include lenses such as a prism lens.

For example, the plurality of light sources LS include a light emitting element emitting red light beams, a light emitting element emitting green light beams, and a light emitting element emitting blue light beams. These light emitting elements may be arranged in the first direction X or may be stacked in the third direction Z. Examples of the light emitting elements include light emitting diodes (LEDs).

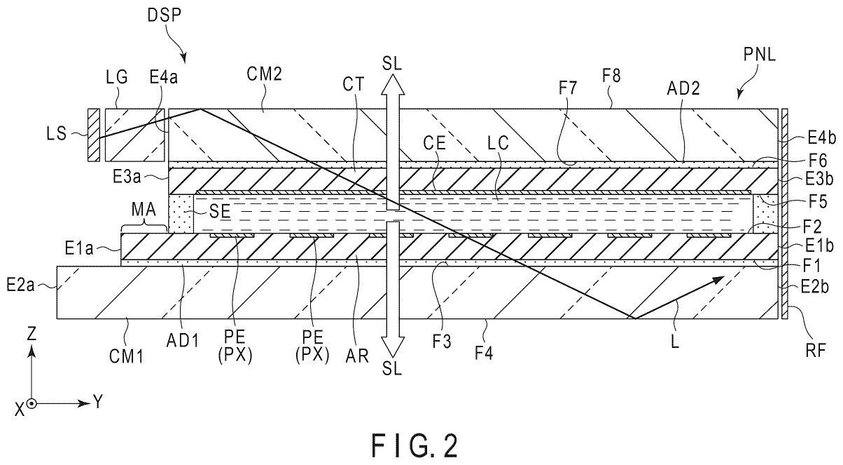

FIG. 2 is a schematic cross-sectional view of the display device DSP of the present embodiment. FIG. 2 schematically shows the structure of the display panel PNL and the like and omits the illustration of components such as the scanning lines G, the signal lines S, and the switching element SW.

The array substrate AR and the counter-substrate CT are bonded together by a sealing material SE. The sealing material SE has a shape which surrounds the display area DA. The liquid crystal layer LC is enclosed in a space surrounded by the sealing material SE.

The array substrate AR comprises the plurality of pixel electrodes PE described above. The counter-substrate CT comprises the common electrode CE described above. The pixel electrodes PE face the common electrode CE with the liquid crystal layer LC sandwiched therebetween. The common electrode CE faces the plurality of pixel electrodes PE.

The plurality of pixel electrodes PE and the common electrode CE are formed on transparent insulating substrates provided in each of the array substrate AR and the counter-substrate CT. These insulating substrates are formed of, for example, glass, but may be formed of plastic. The pixel electrode PE and the common electrode CE are, for example, transparent electrodes formed of transparent conductive materials, such as an indium tin oxide (ITO) or an indium zinc oxide (IZO).

For example, the pixel electrode PE and the common electrode CE are covered with alignment films formed on each of the array substrate AR and the counter-substrate CT. The layout of the pixel electrode PE and the common electrode CE is not limited to this example.

The display panel PNL may further include cover members CM1 and CM2. Both of these cover members CM1 and CM2 are transparent, and are, for example, cover glasses formed of glass. As another example, the cover members CM1 and CM2 may be formed of plastic.

The array substrate AR has a main face F1, a main face F2 on the side opposite to the main face F1, and side faces E1a and E1b, which connect the main face F1 with the main face F2. The cover member CM1 includes a main face F3 facing the main face F1, a main face F4 located on the side opposite to the main face F3, and side faces E2a and E2b, which connect the main face F3 with the main face F4.

The main faces F1 and F3 are bonded together by a transparent first adhesive layer AD1. For example, an optical clear adhesive (OCA) can be used as the first adhesive layer AD1.

The counter-substrate CT has a main face F5 facing the second main face F2 via the liquid crystal layer LC, a main face F6 on the side opposite to the main face F5, and side faces E3a and E3b, which connect the main face F5 with the main face F6. The cover member CM2 has a main face F7 facing the main face F6, a main face F8 located on the side opposite to the main face F7, and side faces E4a and E4b connecting the main face F7 with the main face F8. The main faces F6 and F7 are bonded together by a transparent second adhesive layer AD2. As in the case of the first adhesive layer AD1, the second adhesive layer AD2 is an OCA as well.

The side faces E1a, E2a, E3a, and E4a are all located on a side of the light source LS (an incidence side). The side faces E1b, E2b, E3b, and E4b are all located on the side opposite to the light source LS (an opposite incidence side). Of the array substrate AR, the mounting area MA is formed in a portion that protrudes relative to the side face E3a in the direction opposite to the second direction Y.

In the example shown in FIG. 2, the side faces E2a, E4a, E2b, and E4b are flat faces parallel to the first direction X and the third direction Z. The side faces E2a, E4a, E2b, and E4b may have a cross-sectional shape different from this example.

In the example shown in FIG. 2, a reflective material RF is provided in the vicinity of the side faces E1b, E2b, E3b, and E4b. The reflective material RF is, for example, a reflective tape attached to the side faces E1b, E2b, E3b, and E4b. As another example, the reflective material RF may be a reflective film formed on the side faces E1b, E2b, E3b, and E4b.

The light source LS faces the side face E4a. The light guide LG is provided between the side face E4a and the light source LS. FIG. 2 shows an example of a path of a light beam L emitted from the light source LS. The light beam L emitted from the light source LS is made incident on the side face E4a through the light guide LG.

This light L travels toward the opposite incidence side while repeatedly subjected to total reflection between the main face F8 and the main face F4. The light beam L having reached the side faces E1b, E2b, E3b, and E4b is reflected by the reflective material RF and travels toward the incidence side while repeatedly subjected to total reflection between the main face F8 and the main face F4.

The light beam L is hardly scattered by the liquid crystal layer LC in the vicinity of the pixels PX in the transparent state. Thus, the light beam L does not substantially leak out of the cover member CM1 or the cover member CM2.

On the other hand, the light beam L is scattered by the liquid crystal layer LC in the vicinity of the pixels PX in the scattering state. This scattered light SL is emitted from the cover members CM1 and CM2 and is visually recognized as a display image by a user. The gradation expression of the degree of scattering (luminance) can be realized by defining the voltage to be applied to the pixel electrodes PE in stages in a predetermined range.

In the vicinity of a pixel in the transparent state, the external light that enters the cover member CM1 or CM2 is not substantially scattered and then this external light passes through the liquid crystal layer LC. Thus, when the display panel PNL is viewed from the first cover member CM1 side, the background on the second cover member CM2 side can be visually recognized. When the display panel PNL is viewed from the second cover member CM2 side, the background on the first cover member CM1 side can be visually recognized.

For example, as a system for displaying an image by the display device DSP, the following field sequential system can be used. The field sequential system repeats a first subframe in which a red image is displayed by illuminating the red light emitting elements of the plurality of light sources LS, a second subframe in which a green image is displayed by illuminating the green light emitting elements, and a third subframe in which a blue image is displayed by illuminating the blue light emitting elements.

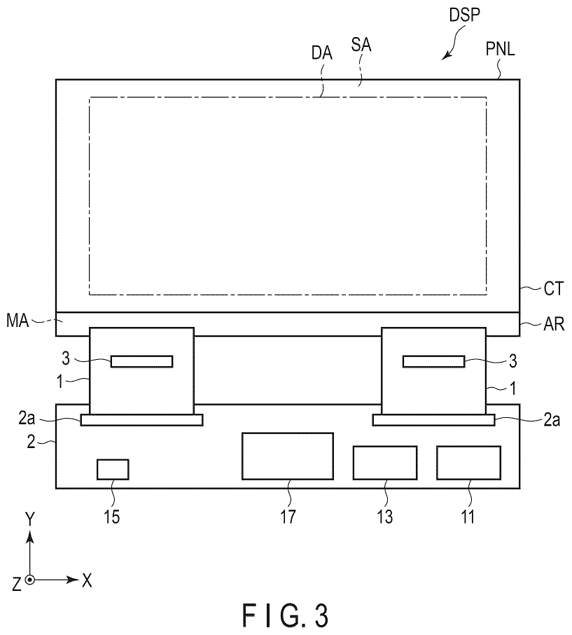

FIG. 3 is a schematic plan view of the display device DSP of the present embodiment. The display device DSP further comprises a plurality of printed circuit boards 1 and a control board 2. The plurality of printed circuit boards 1 are connected to the mounting area MA. Examples of the plurality of printed circuit boards 1 include a flexible printed circuit.

Each of the plurality of printed circuit boards 1 has an IC chip 3. For example, the IC chip 3 includes a drive circuit for displaying images. The IC chip 3 may be provided on the display panel PNL or the control board 2. The number of the printed circuit board 1 may be one or three or more. The plurality of printed circuit boards 1 are connected to the control board 2 via a terminal 2a.

The control board 2 is electrically connected to the display panel PNL via the plurality of printed circuit boards 1. For example, the control board 2 is a printed circuit board that has a rigidity greater than that of the printed circuit board 1.

The display device DSP further comprises a first power circuit 11, a second power circuit 13, a temperature sensor 15, and a control circuit 17. In the present embodiment, the first power circuit 11, a second power circuit 13, the temperature sensor 15, and the control circuit 17 are provided on, for example, the control board 2. The configuration is not limited to this example.

The first power circuit 11 and the second power circuit 13 are circuits for applying voltages to the common electrode CE. More specifically, the first power circuit 11 is a circuit for applying a common voltage (Vcom) to the common electrode CE. The second power circuit 13 is a circuit for the common electrode CE to function as a heater.

The temperature sensor 15 detects ambient temperature. Here, the ambient temperature refers to ambient temperature of the display panel PNL. That is, the ambient temperature refers to ambient temperature of the liquid crystal layer LC. The ambient temperature is temperature of a place on which the display device DSP is provided.

The temperature sensor 15 detects ambient temperature, for example, while the display device DSP is in operation. The temperature sensor 15 is provided on the control board 2, as described above. For example, the temperature sensor 15 may be provided on the display panel PNL. The temperature sensor 15 is, for example, an element configured to detect ambient temperature.

The control circuit 17 controls the drive of the display device DSP. More specifically, the control circuit 17 has functions of controlling image display in the display area DA, controlling a voltage applied to the common electrode CE based on temperature detected by the temperature sensor 15, and the like.

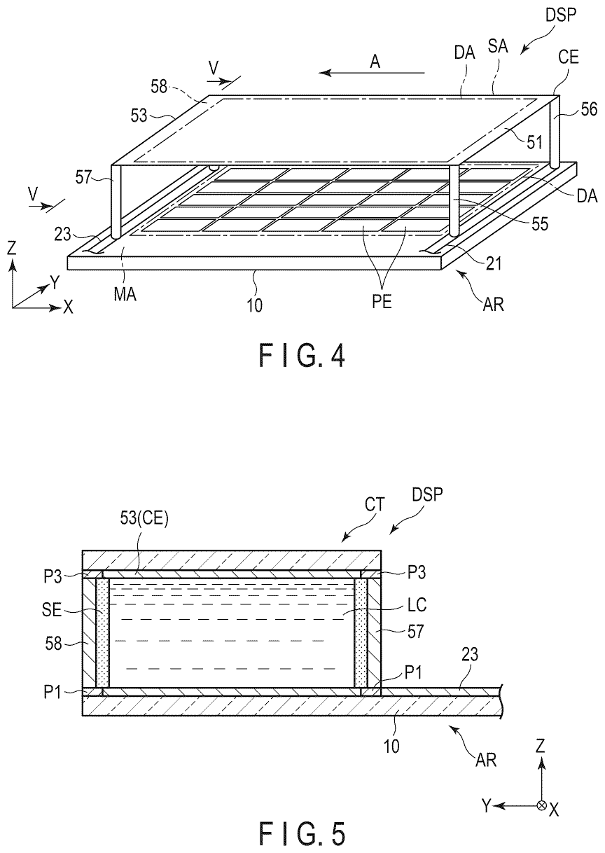

FIG. 4 is a schematic perspective of the display device DSP of the present embodiment. FIG. 5 is a schematic cross-sectional view of the display device DSP along V-V line of FIG. 4. FIG. 4 and FIG. 5 omit illustration of some components.

As described above, the display device DSP comprises the plurality of pixel electrodes PE and the common electrode CE. The plurality of pixel electrodes PE are formed on the insulating substrate 10. The plurality of pixel electrodes PE are provided in the display area DA.

For example, the common electrode CE has a rectangular shape. The size of the common electrode CE is greater than the display area DA. That is, the common electrode CE is provided in the display area DA and the surrounding area SA. The liquid crystal layer LC (shown in FIG. 5) is located between the plurality of pixel electrodes PE and the common electrode CE.

As shown in FIG. 4, the array substrate AR further includes a first circuit portion 21 and a second circuit portion 23. The first circuit portion 21 and the second circuit portion 23 are provided in the surrounding area SA on the insulating substrate 10.

The first circuit portion 21 and the second circuit portion 23 extend in the second direction Y and are spaced apart with intervals in the first direction X. The first circuit portion 21 and the second circuit portion 23 have a liner shape in the example of FIG. 4. The shape is not limited to this example.

For example, the first circuit portion 21 and the second circuit portion 23 are formed of a conductive metal material for forming the signal line S z (shown in FIG. 1) and the scanning line G (shown in FIG. 1) or a transparent conductive material for forming the pixel electrode.

The common electrode CE includes a first end portion 51 and a second end portion 53. As an example, the first end portion 51 is located on one side (the right side in FIG. 4) in the first direction X, and the second end portion 53 is located on the other side (the left side in FIG. 4) in the first direction X. Here, the end portion includes an end and the area in the vicinity of the end. For example, the first end portion 51 and the second end portion 53 have a width in the first direction X and correspond to a strip portion extending in the second direction Y.

The first end portion 51 and the second end portion 53 face the first circuit portion 21 and the second circuit portion 23 in the third direction Z. With respect to the display area DA, the display area DA is formed between the first circuit portion 21 or the first end portion 51 and the second circuit portion 23 or the second end portion 53 in the first direction X.

The display device DSP further comprises first connection portions 55 and 56 and second connection portions 57 and 58. The first connection portions 55 and 56 and the second connection portions 57 and 58 are provided outer than the seal member SE in the surrounding area SA in plan view.

The first connection portions 55 and 56 connect the first circuit portion 21 with the first end portion 51. The second connection portions 57 and 58 connect the second circuit portion 23 with the second end portion 53. Examples of the first connection portions 55 and 56 and the second connection portions 57 and 58 include a conductive adhesive, such as a silver paste.

The surrounding area SA has pads P1 and P3. The pad P1 is electrically connected to the first circuit portion 21 and the second circuit portion 23; the pad P3 is electrically connected to the first end portion 51 and the second end portion 53.

The pad P1 may be formed on the same layer as that of the first circuit portion 21 and the second circuit portion 23. Alternatively, the pad P1 may be formed on a different layer from that of the first circuit portion 21 and the second circuit portion 23. For example, the pad P3 may be formed on the same layer as that of the common electrode CE. Alternatively, the pad P3 may be formed on a different layer from that of the common electrode CE. For example, the pad P3 overlaps the four corner portions of the common electrode CE.

The pad P1 faces the pad P3 in the third direction Z. As shown in FIG. 5, the second connection portions 57 and 58 connect the pad P1 connected to the second circuit portion 23 with the pad P3 connected to the second end portion 53. Similarly to the second connection portions 57 and 58, the first connection portions 55 and 56 connect the pad P1 connected to the first circuit portion 21 with the pad P3 connected to the first end portion 51.

In the common electrode CE, a voltage is applied to the first end portion 51 via the first circuit portion 21 and the first connection portions 55 and 56; a voltage is applied to the second end portion 53 via the second circuit portion 23 and the second connection portions 57 and 58. That is, a voltage applied to the first circuit portion 21 corresponds to a voltage applied to the first end portion 51, and a voltage applied to the second circuit portion 23 corresponds to a voltage applied to the second end portion 53.

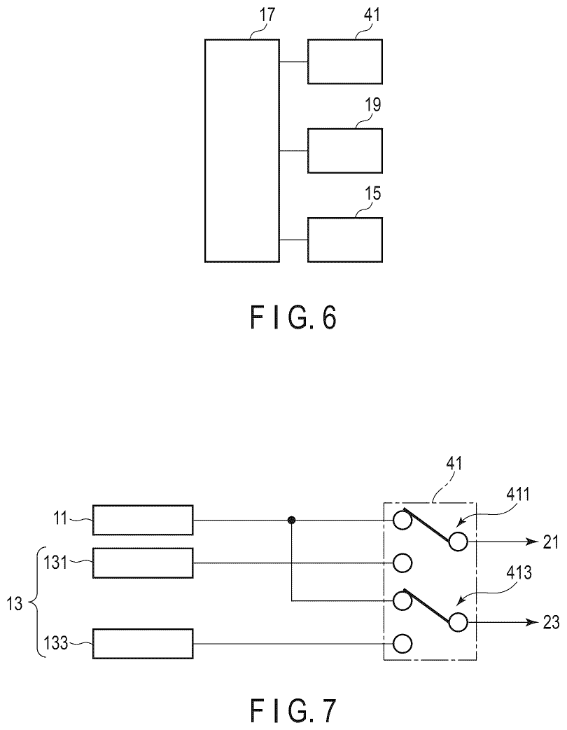

FIG. 6 is a block view containing the control circuit 17 in the present embodiment. The display device DSP further comprises a storage unit 19. The storage unit 19 includes various types of information such as program for controlling the display device DSP and pieces of data including a specific temperature to be described later.

For example, the control circuit 17 reads program from the storage unit 19 to execute each process. The storage unit 19 may be a part of the control circuit 17 or a component different from the control circuit 17. Examples of the storage unit 19 include a memory and a ROM. These examples do not limit the configuration.

The display device DSP further comprises a switch circuit 41. The switch circuit 41 functions as a switch that switches a connection path of the first circuit portion 21 and the second circuit portion 23. The switch circuit 41 is constituted by, for example, combining a plurality of thin-film transistors.

The control circuit 17 is electrically connected to the storage unit 19, the temperature sensor 15, and the switch circuit 41. Thus, the control circuit 17 can read necessary information form the storage unit 19, obtain temperature information detected by the temperature sensor 15, and control the switch circuit 41.

FIG. 7 is a circuit diagram of the display device DSP of the embodiment. The second power circuit 13 includes a power source unit 131, which can be connected to the first circuit portion 21, and a power source unit 133, which can be connected to the second circuit portion 23. The power source unit 131 applies a voltage having an electric potential different from that of the power source unit 133.

The switch circuit 41 includes switches 411 and 413. One end of the switch 411 is connected to the first circuit portion 21; the other end of the switch 411 is connected to the first power circuit 11 and the power source unit 131. One end of the switch 413 is connected to the second circuit portion 23; the other end of the switch 413 is connected to the first power circuit 11 and the power source unit 133.

When the switches 411 and 413 are connected to the first power circuit 11, voltages having the same electric potential (common voltages) are applied to the first circuit portion 21 and the second circuit portion 23. When the switches 411 and 413 are connected to the second power circuit 13, voltages with different potentials are respectively applied to the first circuit portion 21 and the second circuit portion 23.

Next, heat control in the control circuit 17 will be described.

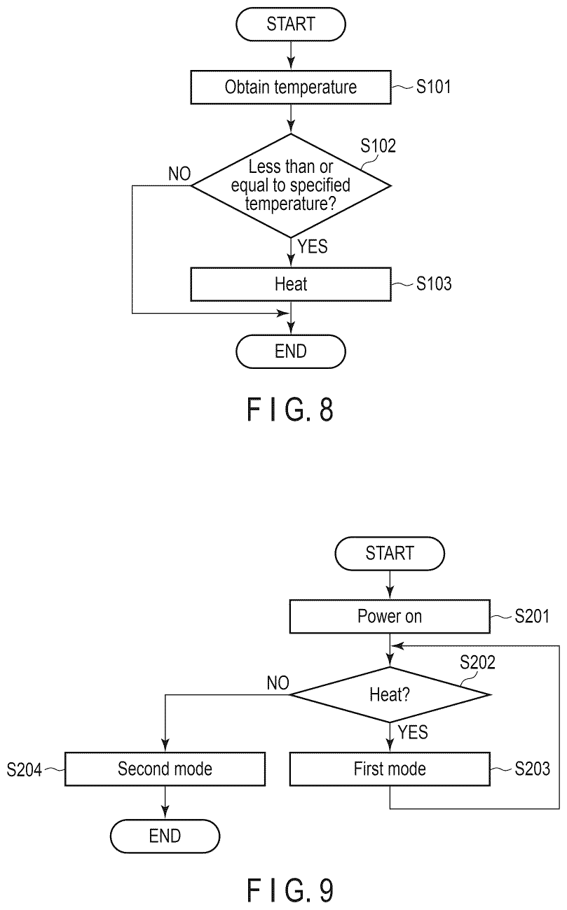

FIG. 8 is a flowchart showing an example of heat control in the control circuit 17. In the display device DSP, the heat control in the control circuit 17 allows the common electrode CE to function as a heater to heat the liquid crystal layer LC. That is, the common electrode CE is configured such that it can heat the liquid crystal layer LC.

First, the control circuit 17 obtains ambient temperature detected by the temperature sensor 15 (a step S101). The control circuit 17 can obtain ambient temperature from the temperature sensor 15 either before or after image display in the display device DSP. The control circuit 17 may be configured to allow a user to obtain ambient temperature at a given timing point.

Next, based on an ambient temperature obtained from the temperature sensor 15, the control circuit 17 determines whether the temperature is less than or equal to a specified temperature (a step S102). The specified temperature is set for the common electrode CE to heat the liquid crystal layer LC in cases where the display device DSP is provided in low-temperature environment such as cold climate areas. The storage unit 19 (shown in FIG. 6) preliminarily stores the specified temperature.

When the ambient temperature is less than or equal to the specified temperature (YES in a step 102), the control circuit 17 performs the heat control (a step S103). More specifically, the control circuit 17 controls the switch circuit 41 such that the second power circuit 13 is connected with the switches 411 and 413. This configuration enables applying voltages having different potentials respectively to the first circuit portion 21 and the first end portion 51, and the second circuit portion 23 and the second end portion 53.

At this time, a voltage applied to the first circuit portion 21 is defined as a first voltage VC1 and a voltage applied to the second circuit portion 23 is defined as a second voltage VC2. That is, when the ambient temperature is less than or equal to the specified temperature, the control circuit 17 controls voltages to apply the first voltage VC1 to the first circuit portion 21 and the second voltage VC2 to the second circuit portion 23. The first voltage VC1 is different from the second voltage VC2.

For example, when the first voltage VC1 is greater than the second voltage VC2, current runs from the first end portion 51 to the second end portion 53 in a direction A in FIG. 4. The common electrode CE is composed of a transparent conductive material and thus has an electric resistance higher than that of a metal material.

The common electrode CE is heated by a current running through it. Heating the common electrode CE heats the display panel PNL including the liquid crystal layer LC over the entire display area DA.

More specifically, when the common electrode CE has a resistance of around 50Ω and the first voltage VC1 is 15 V and the second voltage VC2 is 0 V, a heating amount in the common electrode CE is around 4.5 W.

The heat control by the control circuit 17 may be set to end, for example, after a specified time has passed. The heat control by the control circuit 17 may be set to repeated, for example, until ambient temperature exceeds a specific temperature.

When the ambient temperature is higher than the specified temperature (NO in the step 102), the control circuit 17 does not perform the heat control. More specifically, the control circuit 17 controls the switch circuit 41 such that the first power circuit 11 is connected with the switches 411 and 413.

That is, when the ambient temperature is higher than the specified temperature, the control circuit 17 performs control such that a common voltage having the same electric potential is applied to the first circuit portion 21 and the second circuit portion 23. In this manner, the control circuit 17 can control voltages applied to the first circuit portion 21 and the second circuit portion 23 based on temperatures detected by the temperature sensor 15.

Next, image display control in the control circuit 17 will be described.

FIG. 9 is a flowchart showing an example of the image display control in the control circuit 17. The control circuit 17 selects modes in which an image is displayed based on whether the heat control is performed.

First, when power is input to the display device DSP (a step S201), the control circuit 17 determines whether the heat control is performed (a step S202). The heat control is performed according to, for example, a flowchart in FIG. 8.

Next, when the heat control is determined as being performed (YES in the step S202), the control circuit 17 performs control such that an image is displayed in the first mode (a step S203). For example, while an image is displayed in the first mode, the control circuit 17 repeats processes in the step S202 to the step S203.

In contrast, when the heat control is not determined as being performed (NO in the step S202), the control circuit 17 performs control such that an image is displayed in the second mode (a step S204).

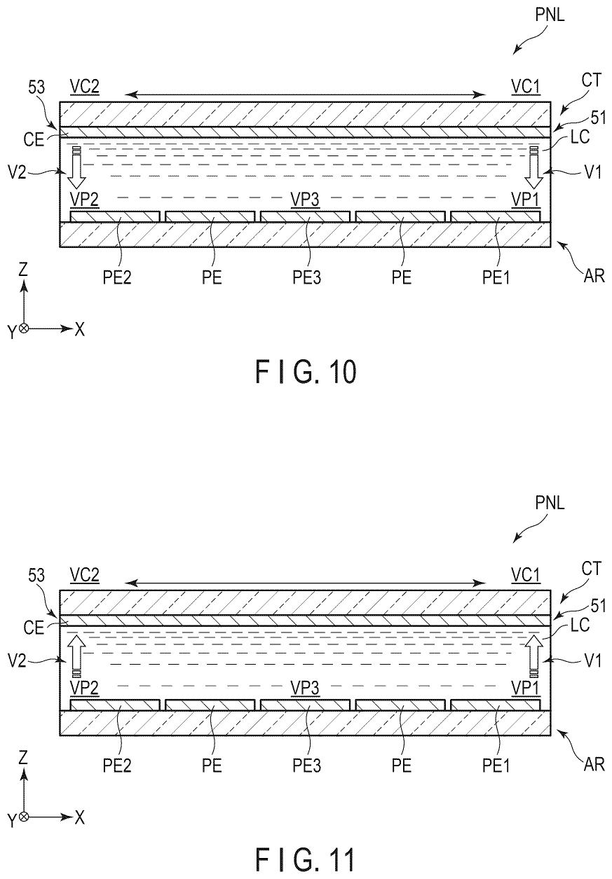

The following describes the first mode. FIG. 10 and FIG. 11 are diagrams for explanations on the first mode in the image display control.

In cases where the first mode is selected, the heat control is being performed. With respect to the first end portion 51 and the second end portion 53, the first voltage VC1 is applied to the first end portion 51 and the second voltage VC2 is supplied to the second end portion 53.

With respect to the entire common electrode CE, the voltage of the common electrode CE varies depending on positions in the first direction X. Thus, the control circuit 17 controls voltages applied to the plurality of pixel electrodes PE based on the first voltage VC1 and the second voltage VC2. More specifically, the control circuit 17 performs control such that voltages applied to the plurality of pixel electrodes PE are different from one another based on the first voltage VC1 and the second voltage VC2.

As shown in FIG. 10 and FIG. 11, among the plurality of pixel electrodes PE, a voltage of the pixel electrode PE1 located on the first end portion 51 side (the right side in the figures) is defined as a voltage VP1, a voltage of the pixel electrode PE2 located on the second end portion 53 side (the left side in the figures) is defined as a voltage VP2, and a voltage of the pixel electrode PE3 located on the center in the X direction is defined as a voltage VP3.

An electric potential difference between the common electrode CE and the pixel electrode PE1 is defined as a voltage V1; an electric potential difference between the common electrode CE and the pixel electrode PE2 is defined as a voltage V2. With respect to the liquid crystal layer LC, the voltage V1 corresponds to an electric potential difference in the first edge portion 51 side and the voltage V2 corresponds to an electric potential difference in the second end portion 53 side.

As an example, the following descriptions assume white raster display. Here, the white raster display signifies displaying white in the entire display area DA by applying the same voltage to the liquid crystal layers of all pixels.

In the first mode in the image display control, voltages applied to the pixel electrodes PE vary based on the first voltage VC1 and the second voltage VC2 according to positions in the first direction X (undergoing offset).

The voltages applied to plurality of the pixel electrodes PE are the same voltages as those applied to the plurality of signal lines S (shown in FIG. 1). The control circuit 17 performs control, for example, via the drive circuit (not shown) such that voltages applied to the plurality of signal lines S vary according to positions in the first direction X. Voltages applied to the signal lines S are constant in the second direction Y.

For example, when the first voltage VC1 is 15 V and the second voltage VC2 is 0 V, the control circuit 17 controls voltages such that the voltage VP1 of the pixel electrode PE1 is 35 V, the voltage V2 of the pixel electrode PE2 is 20 V, and the voltage VP3 of the pixel electrode PE3 is 27.5 V.

Thus, the voltage V1 is 20 V, the voltage V2 is 20 V, and an electric potential difference in the center portion in the first direction X is 20 V as well. Thus, an electric potential difference between the plurality of pixel electrodes PE and the common electrode CE are unlikely to occur according to positions in the first direction X. Thus, the display area DA can achieve unified white raster display in the first direction X.

The above descriptions have described the cases where positive (+) voltages are applied to the liquid crystal layer LC with reference to FIG. 10. The following describes cases where the common electrode CE is driven in the inverted manner and thus negative (−) voltages are applied to the liquid crystal layer LC.

In the example in FIG. 11, when the first voltage VC1 is 35 V and the second voltage VC2 is 20 V, the control circuit 17 controls voltages such that the voltage VP1 of the pixel electrode PE1 is 15 V, the voltage V2 of the pixel electrode PE2 is 0 V, and the voltage VP3 of the pixel electrode PE3 is 7.5 V.

In this example as well, the voltage V1 is 20 V, the voltage V2 is 20 V, and an electric potential difference in the center portion in the first direction X is 20 V. Thus, an electric potential difference between the plurality of pixel electrodes PE and the common electrode CE are unlikely to occur according to positions in the first direction X.

With respect to tow pixel electrodes PEL and PE2 among the plurality of pixel electrodes PE, the control circuit 17 controls voltages applied to the pixel electrodes PEL and PE2 such that an electric potential difference is constant between the pixel electrode PE1 and the common electrode CE and between the pixel electrode PE2 and the common electrode CE. This enables forming the same display status in the display area DA.

The above have described the common-inverted system. The following describes the common DC system. The common DC system involves a frame-inversion drive and has a constant voltage of the common electrode CE.

The above descriptions with reference to FIG. 10 apply to cases with positive voltage (+) in this system as well. The following describes cases where voltages applied to the plurality of pixel electrodes PE are inverted (negative (−)).

In the example in FIG. 11, when the first voltage VC1 is 15 V and the second voltage VC2 is 0 V, the control circuit 17 controls voltages such that the voltage VP1 of the pixel electrode PE1 is-5 V, the voltage V2 of the pixel electrode PE2 is-20 V, and the voltage VP3 of the pixel electrode PE3 is-12.5 V.

In this example as well, the voltage V1 is 20 V, the voltage V2 is 20 V, and an electric potential difference in the center portion in the first direction X is 20 V. Thus, an electric potential difference between the plurality of pixel electrodes PE and the common electrode CE are unlikely to occur according to positions in the first direction X.

Voltages applied to the plurality of pixel electrodes PE are preliminarily stored in the storage unit 19 (shown in FIG. 6) in the control circuit 17. The above describes the white raster display. In other image displays as well, voltages applied to the plurality of signal lines S are controlled such that voltage vary in positions in the first direction based on voltages supplied to the first circuit portion 21 and the second circuit portion 23.

As a display device of a comparative example, the following assumes cases where voltages VP1, VP2, and VP3 respectively applied to the pixel electrodes PE1, PE2, and PE3 in the white raster display have the same value.

When the first voltage VC1 is 15 V and the second voltage VC2 is 0 V, for example, the voltage VP1, VP2, and VP3 of the respective pixel electrodes PE1, PE2, and PE3 is 20 V. At this time, the voltage V1 is 5 V and the voltage V2 is 20 V.

Thus, electric potential differences between the plurality of pixel electrodes PE and the common electrode CE vary depending on positions in the first direction X. More specifically, potential differences decrease along the first direction X. This configuration enables displaying gray scale along the first direction X in the display area DA. That is, the display device of the comparative example cannot form the same display status in the display area.

The present embodiment can form the same display status in the display area DA even when the image display control of the control circuit 17 allows the common electrode CE to function as a heater as described above.

The following describes the second mode.

In cases where the second mode is selected, the heat control is not being performed. With respect to the first end portion 51 and the second end portion 53, a common voltage is applied to the first end portion 51 and the second end portion 53.

With respect to the entire common electrode CE, the common electrode CE has essentially constant voltages along the first direction X. Thus, the control circuit 17 controls voltages applied to the plurality of pixel electrodes PE based on the common voltage. For example, in the white raster display, the voltages VP1, VP2, and VP3 of the respective pixel electrodes PE1, PE2, and PE3 are made constant. Thus, an electric potential difference between the plurality of pixel electrodes PE and the common electrode CE are unlikely to occur according to positions in the first direction X.

In this manner, the control circuit 17 can control voltages applied to the plurality of pixel electrodes PE based on voltages applied to the first circuit portion 21 and the second circuit portion 23.

The display device DSP configured as described above can improve display qualities. For example, when the ambient temperature is low (in low-temperature environment), the response speed of the liquid crystal molecules 32 (shown in FIG. 1) may decrease. Such a reaction of the liquid crystal layer LC may decrease the display qualities.

In the present embodiment, the common electrode CE that is a transparent electrode is configured as heatable. The common electrode CE heats the liquid crystal layer LC to increase a temperature of the liquid crystal layer LC to be higher than the ambient temperature. This suppresses decreases in the response speed in the liquid crystal molecules 32.

As a result, the display device DSP can improve display qualities. Form another view point, the display device DSP of the present embodiment is less limited by usage conditions such as ambient temperature.

Further, the present embodiment does not need an additional independent heater to heat the display panel PNL. Thus, the present invention can avoid inconveniences such as arrangement of heaters that increases the display device DSP in size.

The common electrode CE directly heats the liquid crystal layer LC. This enables efficient heating of the liquid crystal layer LC and preventing portions other than the liquid crystal layer LC from being heated. In addition, this can suppress degradation caused by heating of other portions that constitute the display device DSP.

In the present embodiment, the control circuit 17 performs the heat control based on ambient temperature detected by the temperature sensor 15. For example, when the ambient temperature is room temperature, the heat control is not performed. Thus, energy consumption of the display device DSP is saved.

In the present embodiment, the heat control 17 performs the image display control according to whether the heat control is performed or not. Thus, as described with reference to FIG. 9 to FIG. 11, the degradation in display qualities can be suppressed even in cases where the heat control is performed.

As described above, the configuration of the present embodiment can improve display qualities. Various other desirable effects can be obtained from the present embodiment.

The heat control of the control circuit 17 is not limited to the above examples. The control circuit 17 may perform control such that the heating amount in the common electrode CE is updated according to elapsed time.

More specifically, the control circuit 17 may control voltages applied to the first circuit portion 21 and the second circuit portion 23 such that an electric potential difference between the first voltage VC1 and the second voltage VC2 at the start of the heat control is greater and then the electric potential difference decreases as the time elapses. By increasing the heating amount at the start of the heat control, the temperature of the liquid crystal layer LC can be swiftly increased and a stable image display in the display device DSP can be swiftly performed.

The display device DSP may further comprise a sensor to detect temperature of the liquid crystal layer LC. In this case, the control circuit 17 may control voltages applied to the first circuit portion 21 and the second circuit portion 23 based on the sensor to maintain constant temperature of the liquid crystal layer LC.

In the present embodiment, voltages applied to the first circuit portion 21 and the second circuit portion 23 are set such that a current flowing through the common electrode CE runs from the first end portion 51 to the second end portion 53 but may be set to run from the second end portion 53 to the first end portion 51.

The present embodiment has described the examples in which a current runs through the common electrode CE along the X axis. This current may run along the Y axis. In this case, the first end portion 51 is located on one side in the second direction Y and the second end portion 53 is located on the other side in the second direction Y.

All of the display devices that can be implemented by a person of ordinary skill in the art through arbitrary design changes to the display device described above as the embodiment of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, even if a person of ordinary skill in the art arbitrarily modifies the above embodiments by adding or deleting a structural element or changing the design of a structural element, or adding or omitting a step or changing the condition of a step, all of the modifications fall within the scope of the present invention as long as they are in keeping with the spirit of the invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. A display device, comprising:
an array substrate including a plurality of pixel electrodes provided in a display area;
a counter-substrate overlapping the array substrate;
a liquid crystal layer including polymer dispersed liquid crystals and located between the array substrate and the counter-substrate, wherein
the counter-substrate includes a transparent electrode facing the plurality of pixel electrodes and capable of heating the liquid crystal layer.

2. The display device of claim 1, wherein
the transparent electrode is provided in the display area and a surrounding area surrounding the display area.

3. The display device of claim 2, wherein
the array substrate further includes a first circuit portion and a second circuit portion,
when the liquid crystal layer is heated by the transparent electrode, the first circuit portion applies a first voltage to the transparent electrode, and the second circuit portion applies a second voltage different from the first voltage to the transparent electrode, and
the display area is located between the first circuit portion and the second circuit portion.

4. The display device of claim 3, wherein
the transparent electrode includes:
a first end portion facing the first circuit portion and supplied with the first voltage; and
a second end portion facing the second circuit portion and supplied with the second voltage.

5. The display device of claim 4, further comprising:
a first connection portion connecting the first circuit portion with the first end portion; and
a second connection portion connecting the second circuit portion with the second end portion.

6. The display device of claim 5, further comprising:
a first pad provided in the surrounding area and a second pad facing the first pat, wherein
the first pad is connected to the first circuit portion and the second circuit portion,
the second pad is connected to the first end portion and the second end portion,
the first connection portion connects the first circuit portion with the second end portion via the first pad and the second pad, and
the second connection portion connects the second circuit portion with the second end portion via the first pad and the second pad.

7. The display device of claim 1, further comprising:
a temperature sensor detecting a temperature around the liquid crystal layer.

8. The display device of claim 7, further comprising:
a control circuit, wherein
the array substrate further includes a first circuit portion and a second circuit portion,
when the liquid crystal layer is heated by the transparent electrode, the first circuit portion applies a first voltage to the transparent electrode and the second circuit portion applies a second voltage different from the first voltage to the transparent electrode, and
the control circuit controls voltages applied to the first circuit portion and the second circuit portion based on the temperature detected by the temperature sensor.

9. The display device of claim 8, wherein
when the temperature detected by the temperature sensor is greater than a specified temperature, the control circuit performs control such the voltages applied to the first circuit portion and the second circuit portion have the same electric potential, and
when the temperature detected by the temperature sensor is smaller than or equal to the specified temperature, the control circuit performs control such the first voltage is applied to the first circuit portion and the second voltage is applied to second circuit portion.

10. The display device of claim 9, further comprising:
a first power circuit to apply voltages having the same electric potential to the first circuit portion and the second circuit portion; and
a second power circuit to apply the first voltage to the first circuit portion and the second voltage to the second circuit portion.

11. The display device of claim 10, wherein
when the temperature detected by the temperature sensor is greater than the specified temperature, the control circuit connects the first circuit portion and the second circuit portion with the first power circuit, and
when the temperature detected by the temperature sensor is smaller than or equal to the specified temperature, the control circuit connects the first circuit portion and the second circuit portion with the second power circuit.

12. The display device of claim 9, wherein
the control circuit further controls voltages applied to the plurality of pixel electrodes based on the voltages applied to the first circuit portion and the second circuit portion.

13. The display device of claim 12, wherein
when the same display state is produced, the control circuit controls each of the voltages applied to two pixel electrodes, of the plurality of pixel electrodes, such that an electric potential difference between the two pixel electrodes and the transparent electrode is constant.
